(19) United States
(12) Patent Application Publication
(10) Pub. No.: US 2017/0005524 A1
(43) Pub. Date: Jan. 5, 2017

(54) RESONANT TYPE TRANSMISSION POWER SUPPLY DEVICE AND RESONANT TYPE TRANSMISSION POWER SUPPLY SYSTEM

(71) Applicant: Mitsubishi Electric Engineering Company, Limited, Tokyo (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: MITSUBISHI ELECTRIC ENGINEERING COMPANY, LIMITED, Tokyo (JP)

(21) Appl. No.: 15/107,330

(22) PCT Filed: Dec. 26, 2013
(86) PCT No.: PCT/JP2013/084838

§ 371 Date: Jun. 22, 2016

(51) Int. Cl. H02J 50/12; H02J 50/60

(52) U.S. Cl. CPC H02J 50/12; H02J 50/60

(57) ABSTRACT

A resonant type transmission power supply device includes a pulse input circuit that inputs a pulse voltage to a transmission antenna at set intervals, a variable resonance frequency circuit that causes the resonance frequency of the transmission antenna to be variable and performs sweep detection of the resonance frequency when a pulse voltage is inputted, a frequency characteristic detecting circuit that detects a frequency characteristic of the transmission antenna when the sweep detection is performed, a foreign object detecting circuit that detects the presence or absence of a foreign object in an electromagnetic field generated from the transmission antenna on the basis of a detection result acquired by the frequency characteristic detecting circuit, and a power control circuit that reduces or stops the supply of electric power to the transmission antenna when a foreign object is detected.

### FIELD OF THE INVENTION

The present invention relates to a resonant type transmission power supply device and a resonant type transmission power supply system that detect the presence or absence of a foreign object in an electromagnetic field generated from a transmission antenna, and, when detecting a foreign object, reduce or stop power transmission.

### BACKGROUND OF THE INVENTION

A conventional power supply device having a function of detecting the presence or absence of a foreign object, as shown in FIG. 17, is known (for example, refer to patent reference 1). In the power supply device disclosed by this patent reference 1, a plurality of sensor coils 102 in each of which its winding axis is orthogonal to a transmission antenna 101 are disposed (only one sensor coil is shown in FIG. 17) so as to detect a foreign object existing in surroundings 103 of the sensor coils 102. A reception antenna (not shown) is configured in the same way.

### RELATED ART DOCUMENT

### Patent Reference

Patent reference 1: Japanese Unexamined Patent Application Publication No. 2013-215073

### SUMMARY OF THE INVENTION

### Problems to be Solved by the Invention

However, because the sensor coils 102 for foreign object detection are disposed separately from the transmission antenna 101 and the reception antenna in the conventional configuration, the following problems arise. A first problem is that the size of the entire device increases by the size of the sensor coils 102. More specifically, because the sensor coils 102 are arranged on the transmission antenna 101 and the reception antenna, the height (thickness) of the device increases especially and its mass also increases. Another problem is that it is difficult to detect a foreign object existing at a long distance away from the transmission antenna 101 and the reception antenna or in the vicinity of the center between the transmission antenna 101 and the reception antenna even if the foreign object exists within the range of the electromagnetic field generated from the transmission antenna 101. A further problem is that because a large number of sensor coils 102 are needed for foreign matter detection, this results in a cause of increase in the cost. A still further problem is that because it is necessary to drive a large number of sensor coils 102 for foreign matter detection, this results in a cause of increase in the power consumption.

The present invention is made in order to solve the above-mentioned problems, and it is therefore an object of the present invention to provide a resonant type transmission power supply device and a resonant type transmission power supply capable of detecting the presence or absence of a foreign object in an electromagnetic field generated from a transmission antenna, and performing reduction or stop of power transmission a foreign object is detected.

### Means for Solving the Problem

According to the present invention, there is provided a resonant type transmission power supply device including: a pulse input circuit to input a pulse voltage to a transmission antenna at set intervals; a variable resonance frequency circuit to cause a resonance frequency of the transmission antenna to be variable and perform sweep detection of the resonance frequency when a pulse voltage is inputted by the pulse input circuit; a frequency characteristic detecting circuit to detect a frequency characteristic of the transmission antenna when the sweep detection of the resonance frequency is performed by the variable resonance frequency circuit; a foreign object detecting circuit to detect the presence or absence of a foreign object in an electromagnetic field generated from the transmission antenna on the basis of a detection result acquired by the frequency characteristic detecting circuit; and a power control circuit to reduce or stop the supply of electric power to the transmission antenna when a foreign object is detected by the foreign object detecting circuit.

### Advantages of the Invention

Because the resonant type transmission power supply device according to the present invention is configured as above, the presence or absence of a foreign object in the electromagnetic field generated from the transmission antenna can be detected, and, when a foreign object is detected, the power transmission can be reduced or stopped.

### BRIEF DESCRIPTION OF THE FIGURES

FIG. 1 is a diagram showing the configuration of a resonant type power transmission system provided with a resonant type transmission power supply device according to Embodiment 1 of the present invention;

FIG. 2 is a diagram showing the configuration of a variable resonance frequency circuit in Embodiment 1 of the present invention;

FIG. 3 is a diagram showing another example of the configuration of the variable resonance frequency circuit in Embodiment 1 of the present invention;

FIG. 4 is a diagram showing the configuration of a variable inductor in Embodiment 1 of the present invention;

FIG. 5 is a diagram showing another example of the configuration of the variable inductor in Embodiment 1 of the present invention;

FIG. 6 is a diagram showing another example of the configuration of the variable inductor in Embodiment 1 of the present invention;

FIG. 7 is a diagram showing the configuration of each of variable capacitors in Embodiment 1 of the present invention;

FIG. 8 is a diagram showing the frequency of a voltage detected by the resonant type transmission power supply device according to Embodiment 1 of the present invention, FIG. 8(a) is a diagram showing a case in which no foreign object exists, and FIG. 8(b) is a diagram showing a case in which a dielectric foreign object exists;

FIG. 9 is a diagram showing the frequency of a current detected by the resonant type transmission power supply device according to Embodiment 1 of the present invention, FIG. 9(a) is a diagram showing a case in which no foreign object exists, and FIG. 9(b) is a diagram showing a case in which a dielectric foreign object exists;

FIG. 10 is a diagram showing the frequency of reflection power detected by the resonant type transmission power supply device according to Embodiment 1 of the present invention, FIG. 10(a) is a diagram showing a case in which no foreign object exists, and FIG. 10(b) is a diagram showing a case in which a dielectric foreign object exists;

FIG. 11 is a diagram showing the phase difference between the voltage and the current, and the amplitudes of the reflection power, the voltage and the current which are detected by the resonant type transmission power supply device according to Embodiment 1 of the present invention, FIG. 11(a) is a diagram showing a case in which no foreign object exists, and FIG. 11(b) is a diagram showing a case in which a dielectric foreign object exists;

FIG. 12 is a diagram showing the frequency of the voltage detected by the resonant type transmission power supply device according to Embodiment 1 of the present invention, FIG. 12(a) is a diagram showing a case in which no foreign object exists, and FIG. 12(b) is a diagram showing a case in which a magnetic foreign object exists;

FIG. 13 is a diagram showing the frequency of the current detected by the resonant type transmission power supply device according to Embodiment 1 of the present invention, FIG. 13(a) is a diagram showing a case in which no foreign object exists, and FIG. 13(b) is a diagram showing a case in which a magnetic foreign object exists;

FIG. 14 is a diagram showing the frequency of the reflection power detected by the resonant type transmission power supply device according to Embodiment 1 of the present invention, FIG. 14(a) is a diagram showing a case in which no foreign object exists, and FIG. 14(b) is a diagram showing a case in which a magnetic foreign object exists;

FIG. 15 is a diagram showing the phase difference between the voltage and the current, and the amplitudes of the reflection power, the voltage and the current which are detected by the resonant type transmission power supply device according to Embodiment 1 of the present invention, FIG. 15(a) is a diagram showing a case in which no foreign object exists, and FIG. 15(b) is a diagram showing a case in which a magnetic foreign object exists;

FIG. 16 is a diagram showing the configuration of a resonant type power transmission system provided with a resonant type transmission power supply system according to Embodiment 2 of the present invention; and

FIG. 17 is a diagram showing the configuration of a conventional power supply device.

### EMBODIMENTS OF THE INVENTION

Hereafter, the preferred embodiments of the present invention will be explained in detail with reference to the drawings.

### Embodiment 1

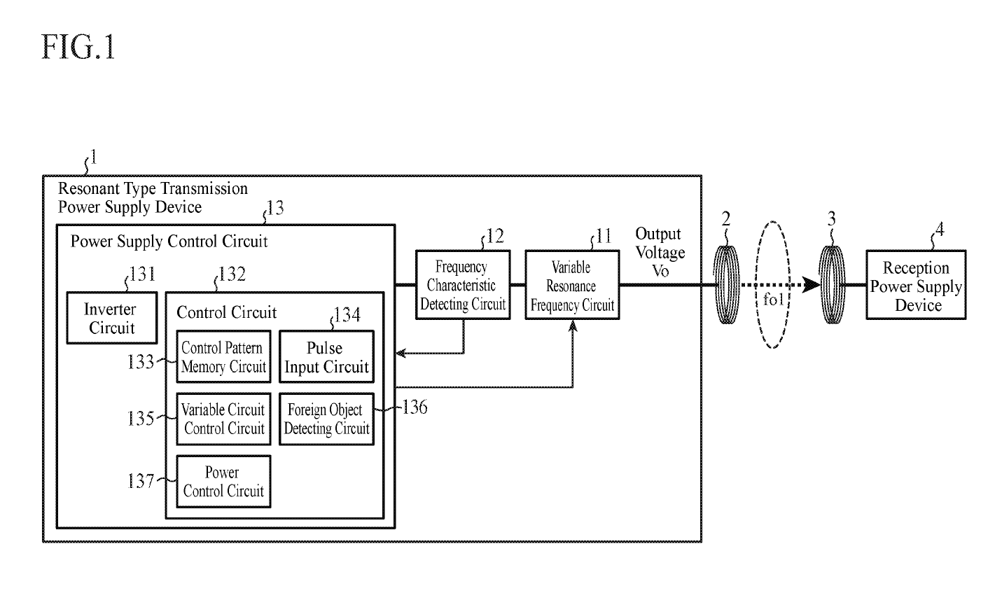

FIG. 1 is a diagram showing the configuration of a resonant type power transmission system provided with a resonant type transmission power supply device 1 according to Embodiment 1 of the present invention.

The resonant type power transmission system transmits electric power including an electric signal. This resonant type power transmission system is configured with the resonant type transmission power supply device 1, a transmission antenna 2, a reception antenna 3, and a reception power supply device 4, as shown in FIG. 1.

The resonant type transmission power supply device 1 is arranged as a stage preceding the transmission antenna 2, and controls the supply of the electric power to the transmission antenna 2. Further, the resonant type transmission power supply device 1 has a function of detecting the presence or absence of a foreign object in an electromagnetic field shown by a broken line in FIG. 1 and generated from the transmission antenna 2 (space including power transmission space between the transmission and reception antennas 2 and 3 and its neighborhood), and a function of, when a foreign object is detected, reducing or stopping the supply of the electric power to the transmission antenna 2. The foreign object includes a dielectric foreign object (a person's hand, an animal or the like) and a magnetic foreign object (metal or the like). The details of this resonant type transmission power supply device 1 will be described below.

The transmission antenna 2 transmits the electric power from the resonant type transmission power supply device 1 to the reception antenna 3 (the transmission is not limited to non-contact one).

The reception antenna 3 receives the electric power from the transmission antenna 2 (the reception is not limited to non-contact one). The electric power received by this reception antenna 13 is supplied to load equipment or the like (not shown) via the reception power supply device 4.

The reception power supply device 4 is arranged between the reception antenna 3 and the load equipment or the like, and rectifies the electric power (AC output) received by the reception antenna 3. This reception power supply device 4 is a power supply circuit of AC input-DC output type or AC input-AC output type.

A transmission method which the resonant type power transmission system uses in the case of wireless power transmission is not limited particularly, and can be any one of a method according to magnetic-field resonance, a method according to electric-field resonance, and a method according to electromagnetic induction.

Next, the configuration of the resonant type transmission power supply device 1 will be explained.

The resonant type transmission power supply device 1 is configured with a variable resonance frequency circuit 11, a frequency characteristic detecting circuit 12 and a power supply control circuit 13.

The variable resonance frequency circuit 11 causes the resonance frequency of the transmission antenna 2 to be variable and performs sweep detection of the resonance frequency under control by a variable circuit control circuit 135, which will be described below, of the power supply control circuit 13 when a pulse voltage is inputted by a pulse input circuit 134. The details of this variable resonance frequency circuit 11 will be described below.

The frequency characteristic detecting circuit 12 detects the frequency characteristics of the transmission antenna 2 when the sweep detection of the resonance frequency is performed by the variable resonance frequency circuit 11. This frequency characteristic detecting circuit 12 detects, as the frequency characteristics, the electric power (reflection power) which returns to the transmission antenna 2 without being able to be power-transmitted from the transmission antenna, the frequencies of a voltage and a current inputted to the transmission antenna 2, the phase difference between the voltage and the current, and the amplitudes of the reflection power, the voltage and the current.

The power supply control circuit 13 detects the presence or absence of a foreign object in the electromagnetic field generated from the transmission antenna 2 on the basis of the detection results acquired by the frequency characteristic detecting circuit 12, and, when detecting a foreign object, reduces or stops the supply of the electric power to the transmission antenna 2. This power supply control circuit 13 is configured with an inverter circuit 131 that performs output of a high frequency alternating current, and a control circuit 132 that controls the output. The inverter circuit 131 is an inverter power supply circuit of AC input-AC output type or DC input-AC output type. The control circuit 132 is configured with a control pattern memory circuit 133, the pulse input circuit 134, the variable circuit control circuit 135, a foreign object detecting circuit 136 and a power control circuit 137.

The control pattern memory circuit 133 is a memory that stores information about the foreign object detection and the power control. The information stored in this control pattern memory circuit 133 includes information showing a threshold for the frequency characteristics (the reflection power, the frequencies of the voltage and the current, the phase difference between the voltage and the current, and the amplitudes of the reflection power, the voltage and the current) , which are used when the foreign object detecting circuit 136 performs the foreign object detection, information showing the types of foreign objects (dielectric objects and magnetic objects) detectable using the frequency characteristics, and information showing the descriptions of the control by the power control circuit 137 according to the types of foreign objects (stop of the electric power supply in the case of a dielectric foreign object, reduction of the electric power supply in the case of a magnetic foreign object, etc.)

The pulse input circuit 134 inputs a pulse voltage to the transmission antenna 2 at set intervals.

The variable circuit control circuit 135 controls the variable resonance frequency circuit 11 to cause the resonance frequency of the transmission antenna 2 to be variable and cause the variable resonance frequency circuit 11 to perform the sweep detection of the resonance frequency when a pulse voltage is inputted by the pulse input circuit 134.

The foreign object detecting circuit 136 detects the presence or absence of a foreign object in the electromagnetic field generated from the transmission antenna 2 according to the information stored in the control pattern memory circuit 133 and on the basis of the detection results acquired by the frequency characteristic detecting circuit 12.

When a foreign object is detected by the foreign object detecting circuit 136, the power control circuit 137 reduces or stops the supply of the electric power to the transmission antenna 2 according to the information stored in the control pattern memory circuit 133.

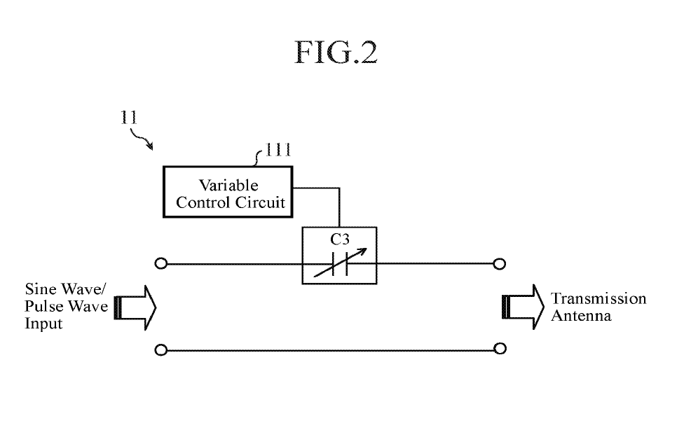

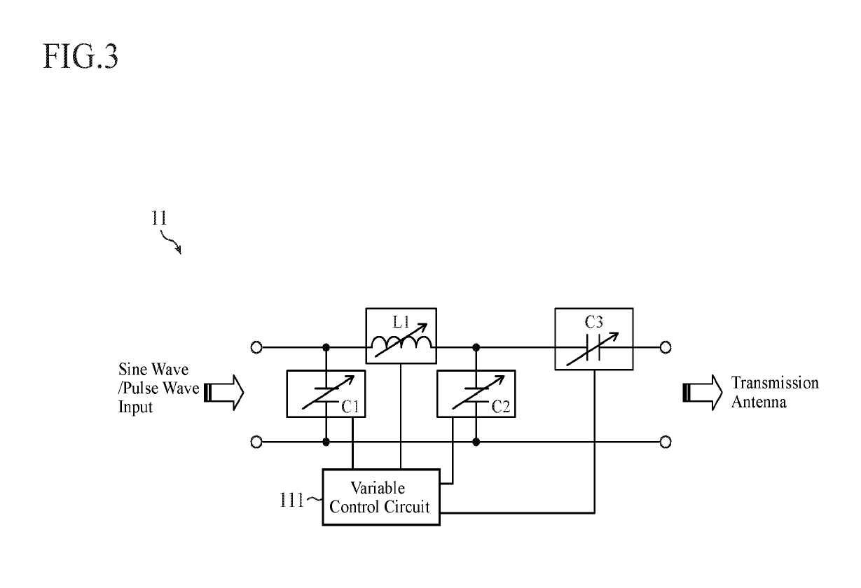

Next, the configuration of the variable resonance frequency circuit 11 will be explained by referring to FIGS. 2 and 3.

The variable resonance frequency circuit 11 shown in FIG. 2 is configured with a variable capacitor C3 and a variable control circuit 111 that causes the capacitance value of this variable capacitor C3 to be variable. Further, the variable resonance frequency circuit 11 shown in FIG. 3 is configured with variable capacitors C1, C2 and C3 and a variable inductor L1, and a variable control circuit 111 that causes the capacitance values of the variable capacitors C1, C2 and C3, and the inductance value (L value) of the variable inductor L1 to be variable.

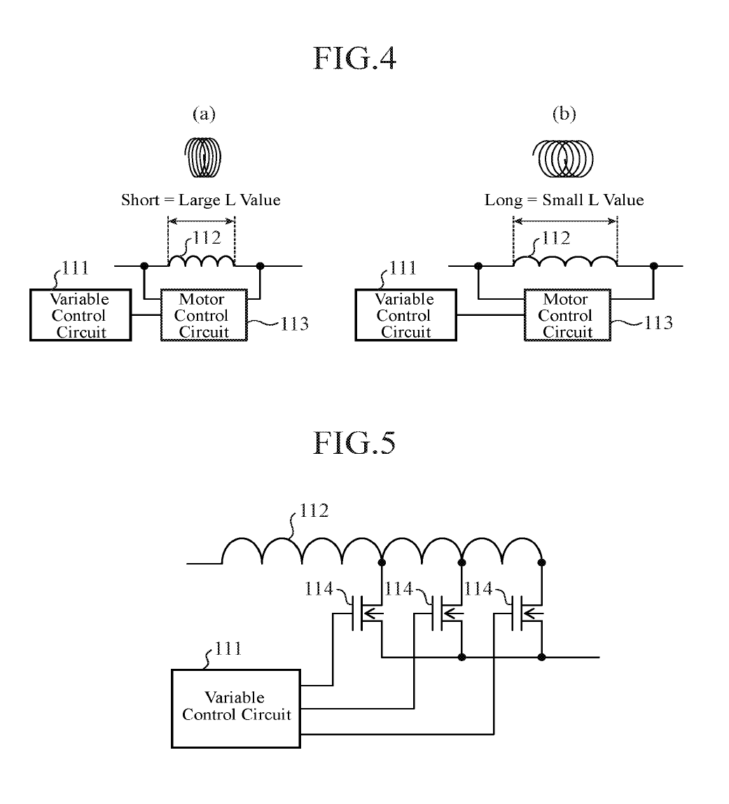

Next, examples of the configuration of the variable inductor L1 will be explained by referring to FIGS. 4 to 6.

In the example of FIG. 4, a motor control circuit 113 is used as an electronic part, and the variable inductor L1 is of a type of automatically causing the magnetic path length of a coil 112 to be variable by using this motor control circuit 113. In this configuration, the inductance value is caused to be variable by driving the motor control circuit 113 by using the variable control circuit 111 to cause the magnetic path length of the coil 112 to be physically variable. In the examples of FIGS. 4(a) and 4(b), the number of turns of the coil 112 is the same.

Further, in the example of FIG. 5, field effect transistors (FETs) 114 are used as an electronic part, and the variable inductor L1 is of a type of automatically adjusting the number of turns of a coil 112 by using these FETs 114. In this configuration, one FET 114 is connected to each point of the coil 112 having a certain number of turns, and switching between ON and OFF of each of the FETs 114 is performed by the variable control circuit 111 or switching of pulse duration modulation (PWM) or the like is performed by the variable control circuit 111 so as to cause the number of turns of the coil 112 to be variable, thereby causing the inductance value to be variable. The FETs 114 are elements, such as Si-MOSFETs, SiC-MOSFETs, GaN-FETs or FETs for RF (Radio Frequency), or are configured into a body diode of off type in which such elements are connected in series.

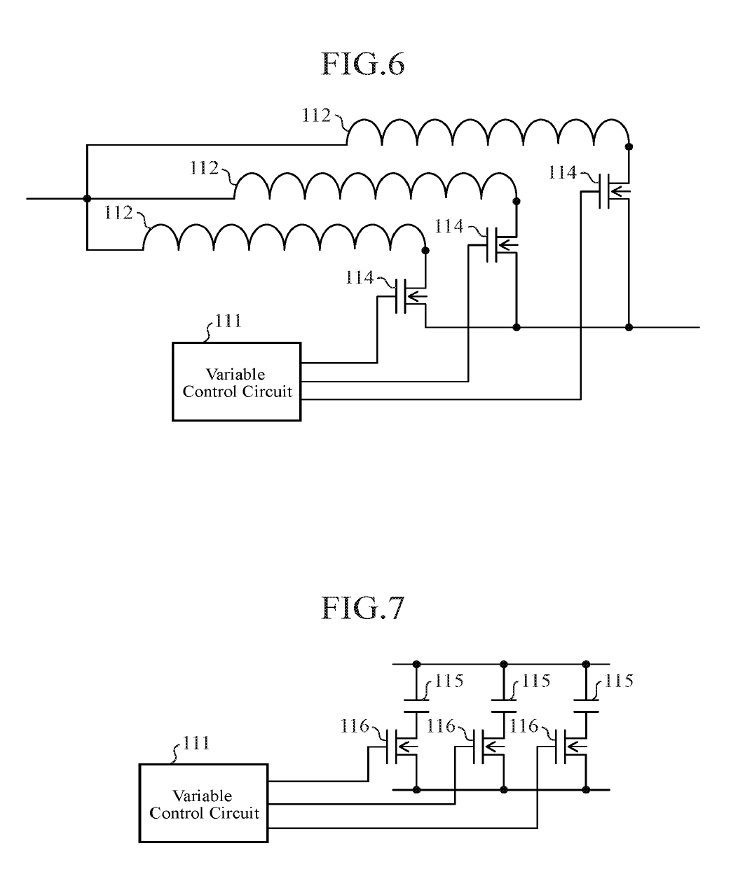

Further, in the example of FIG. 6, FETs 114 are used as an electronic part, and the variable inductor L1 is of a type of automatically causing coils 112 connected in parallel to be variable by using these FETs 114. In this configuration, one FET 114 is connected to each of the coils 112 connected in parallel, and switching between ON and OFF of each of the FETs 114 is performed by the variable control circuit 111, or switching of pulse duration modulation (PWM) or the like is performed by the variable control circuit 111 so as to cause the number of coils 112 connected in parallel to be variable, thereby causing the inductance value to be variable. The FETs 114 are elements, such as Si-MOSFETs, SiC-MOSFETs, GaN-FETs or FETs for RF, or are configured into a body diode of off type in which such elements are connected in series.

Next, an example of the configuration of each of the variable capacitors C1, C2 and C3 will be explained by referring to FIG. 7.

In the example of FIG. 7, FETs 116 are used as an electronic part, and each of the variable capacitors C1, C2 and C3 is of a type of automatically causing the number of capacitors 115 connected in parallel to be variable by using these FETs 116. In this configuration, one FET 116 is connected to each of the capacitors 115 connected in parallel, and switching between ON and OFF of each of the FETs 116 is performed by the variable control circuit 111, or switching of pulse duration modulation (PWM) or the like is performed by the variable control circuit 111 so as to cause the number of capacitors 115 connected in parallel to be variable, thereby causing the capacitance value to be variable. The FETs 116 are elements, such as Si-MOSFETs, SiC-MOSFETs, GaN-FETs or FETs for RF, or are configured into a body diode of off type in which such elements are connected in series.

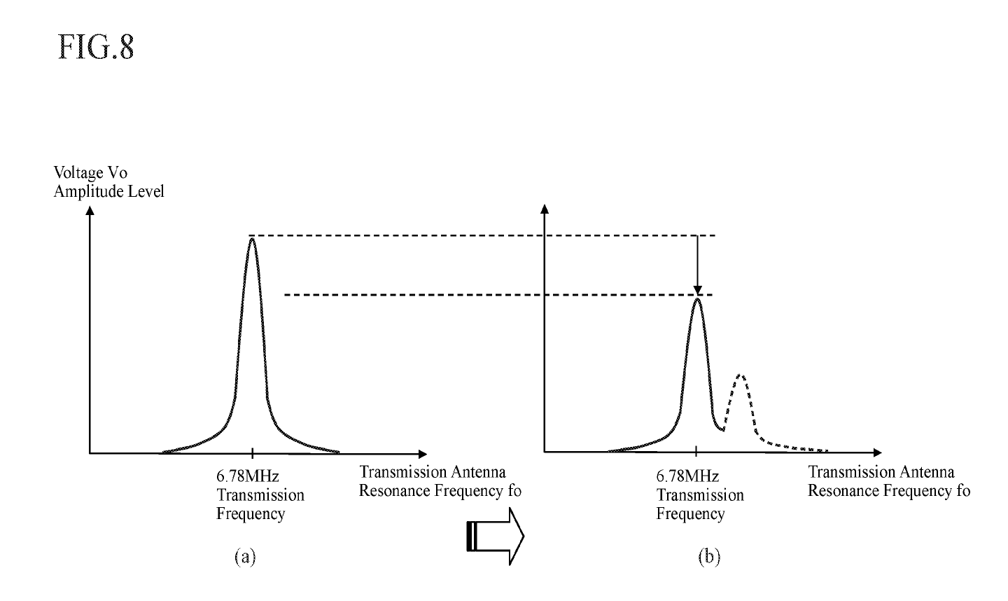

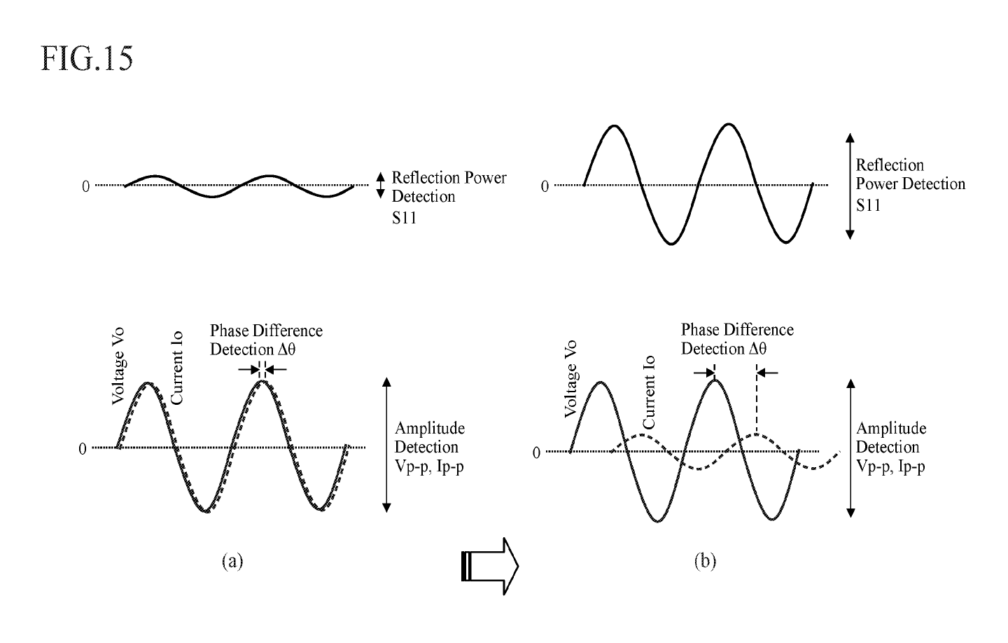

Next, the operation of the resonant type transmission power supply device 1 configured as above will be explained by referring to FIGS. 8 and 15. Hereafter, it is assumed that the transmission frequency of the resonant type power transmission system falls within a 6.78 MHz band.

In the resonant type power transmission system, AC or DC power is supplied to the power supply control circuit 13 of the resonant type transmission power supply device 1, and the inverter circuit 131 of the power supply control circuit 13 supplies an AC output having a high frequency to the transmission antenna 2. The electric power supplied to the transmission antenna 2 resonates at the AC frequency and is transmitted from the transmission antenna 2 to the reception antenna 3. AC output of the electric power received by the reception antenna 3 to the reception power supply device 4 is performed. The reception power supply device 4 then rectifies the electric power and performs DC or AC output of the electric power.

On the other hand, in the resonant type transmission power supply device 1, by inputting a pulse voltage in a low frequency kHz band to the transmission antenna 2 at the set intervals, the sweep detection of the resonance frequency of the transmission antenna 2 is performed by using a high frequency component in a MHz band. The frequency characteristic detecting circuit 12 then detects the frequency characteristics at that time, and transmits a signal showing the characteristics to the power supply control circuit 13. The control circuit 132 of the power supply control circuit 13 then detects the presence or absence of a foreign object in the electromagnetic field generated from the transmission antenna 2, thereby controlling the AC output to the transmission antenna 2.

When no foreign object exists in the electromagnetic field generated from the transmission antenna 2, the frequency of the reflection power from the transmission antenna 2, the frequency of the voltage inputted to the transmission antenna 2, the frequency of the current inputted to the transmission antenna 2, the phase difference between the voltage and the current, and the amplitudes of the reflection power, the voltage and the current are as shown in FIGS. 8(a) to 15(a).

In contrast, when a dielectric foreign object (a person' s hand, an animal or the like) exists in the electromagnetic field generated from the transmission antenna 2, the frequency of the voltage has a waveform as shown in FIG. 8(b). More specifically, the amplitude of the voltage at the transmission frequency decreases under the influence of the foreign object, and a resonance due to the foreign object occurs at a frequency different from the transmission frequency.

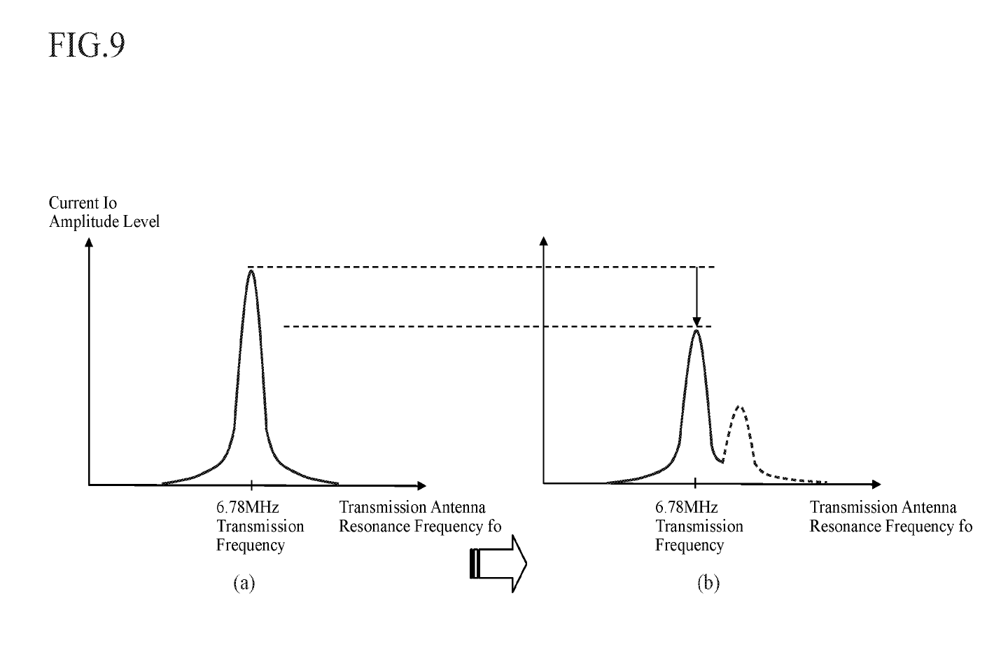

Further, when a dielectric foreign object exists, the frequency of the current has a waveform as shown in FIG. 9(b). More specifically, the amplitude of the current at the transmission frequency decreases under the influence of the foreign object, and a resonance due to the foreign object occurs at a frequency different from the transmission frequency.

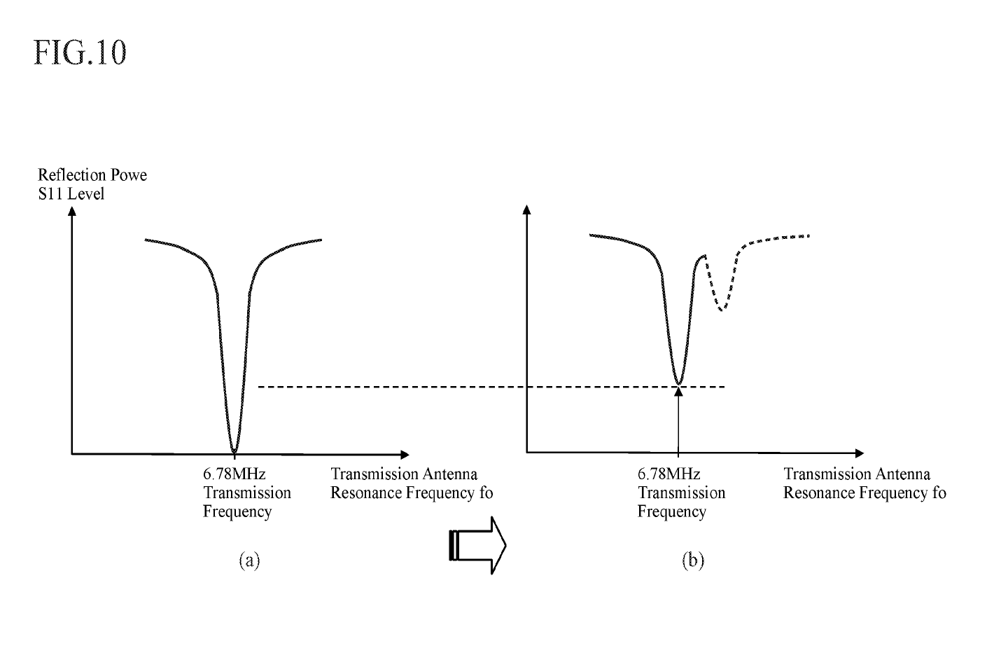

Further, when a dielectric foreign object exists, the frequency of the reflection power has a waveform as shown in FIG. 10(b). More specifically, the reflection power at the transmission frequency increases under the influence of the foreign object, and a resonance due to the foreign object occurs at a frequency different from the transmission frequency.

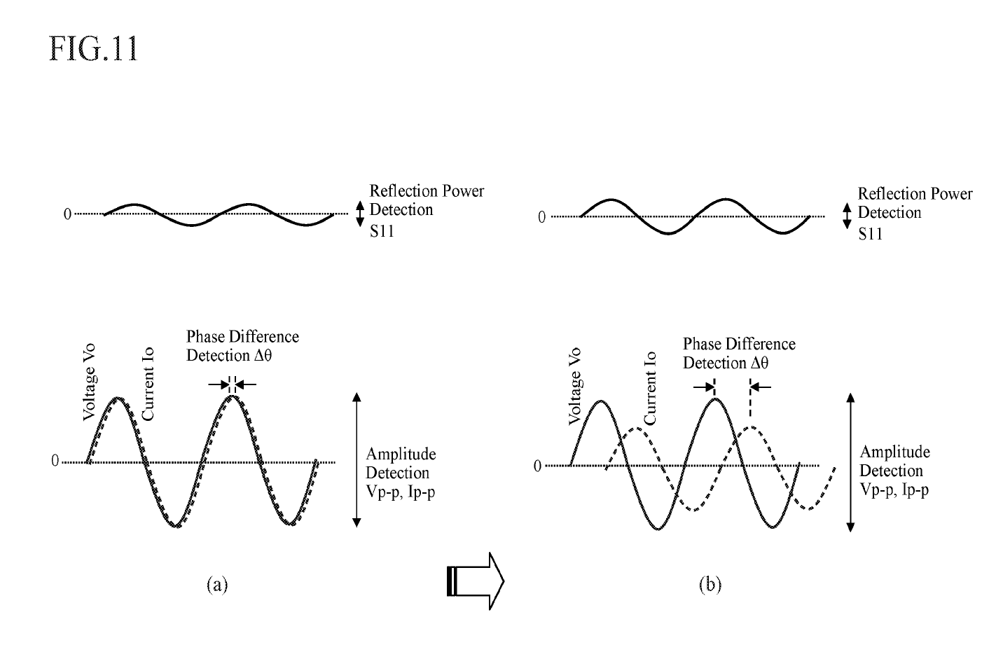

Further, when a dielectric foreign object exists, the phase difference between the voltage and the current, and the amplitudes of the reflection power, the voltage and the current have waveforms as shown in FIG. 11(b). More specifically, because the power transmission is blocked by the foreign object, the reflection power increases as compared with the case in which no foreign object exists, as shown in an upper portion of FIG. 11. Further, as shown in a lower portion of FIG. 11, the phase difference between the voltage and the current increases and the amplitudes of the voltage and the current are changed.

When detecting a dielectric foreign object, the power supply control circuit 13 then stops the supply of the electric power to the transmission antenna 2, for example.

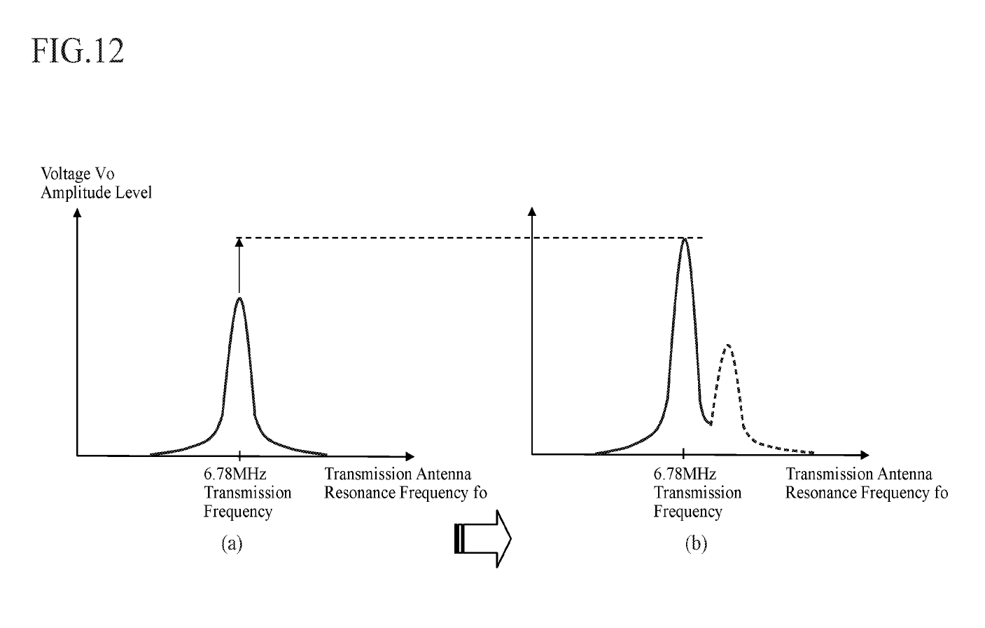

In contrast, when a magnetic foreign object (metal or the like) exists in the electromagnetic field generated from the transmission antenna 2, the frequency of the voltage has a waveform as shown in FIG. 12(b). More specifically, the amplitude of the voltage at the transmission frequency increases under the influence of the foreign object, and a resonance due to the foreign object occurs at a frequency different from the transmission frequency.

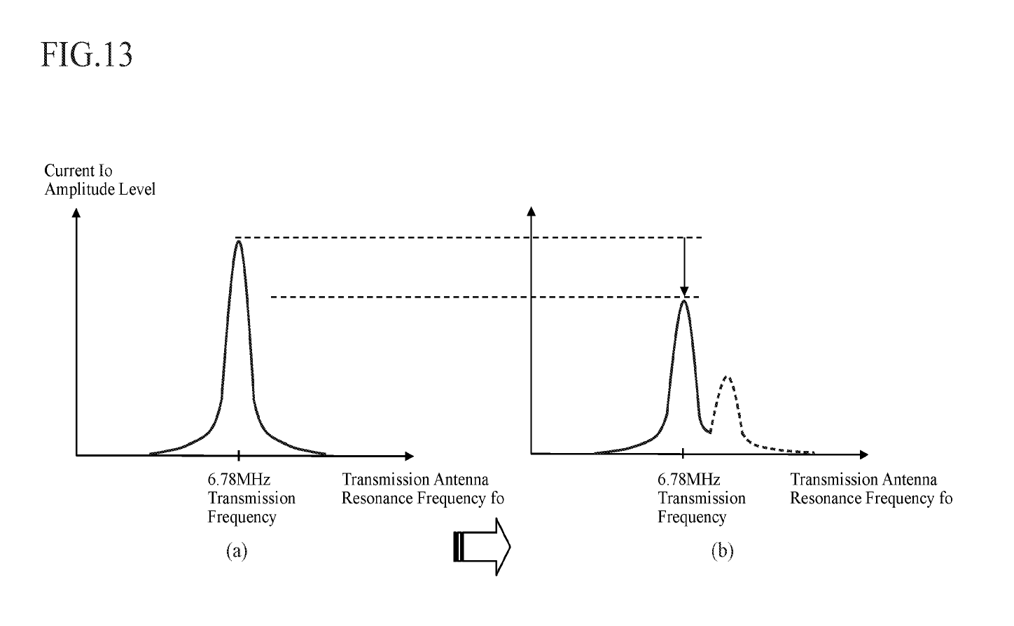

Further, when a magnetic foreign object exists, the frequency of the current has a waveform as shown in FIG. 13(b). More specifically, the amplitude of the current at the transmission frequency decreases under the influence of the foreign object, and a resonance due to the foreign object occurs at a frequency different from the transmission frequency.

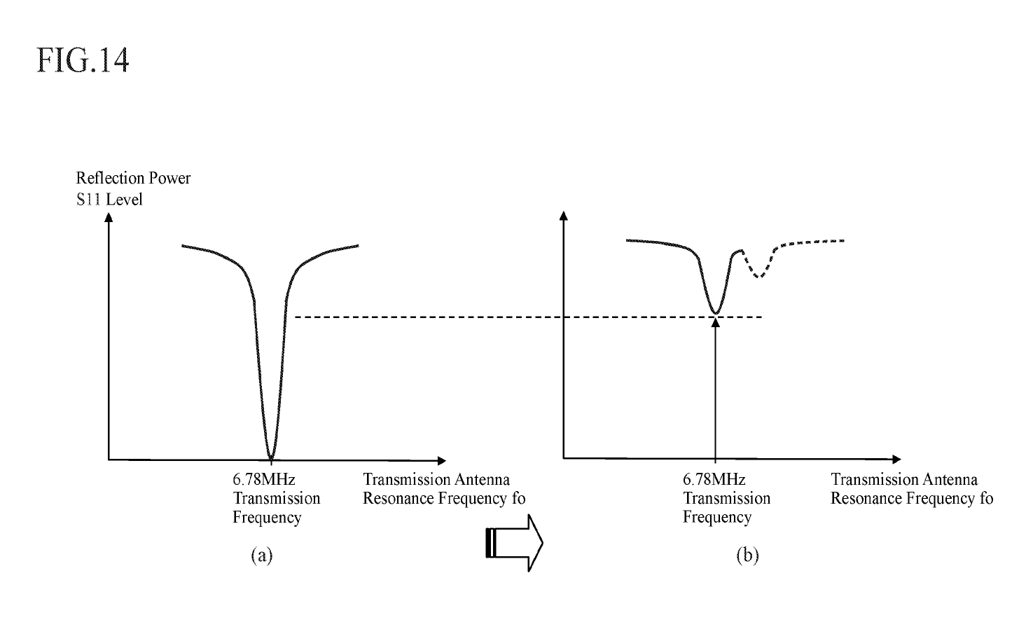

Further, when a magnetic foreign object exists, the frequency of the reflection power has a waveform as shown in FIG. 14(b). More specifically, the reflection power at the transmission frequency increases under the influence of the foreign object, and a resonance due to the foreign object occurs at a frequency different from the transmission frequency.

Further, when a magnetic foreign object exists, the phase difference between the voltage and the current, and the amplitudes of the reflection power, the voltage and the current have waveforms as shown in FIG. 15(b). More specifically, because the power transmission is blocked by the foreign object, the reflection power increases as compared with the case in which no foreign object exists, as shown in an upper portion of FIG. 15. Further, as shown in a lower portion of FIG. 15, the phase difference between the voltage and the current is changed, the amplitude of the voltage increases, and the amplitude of the current decreases.

When detecting a magnetic foreign object, the power supply control circuit 13 then reduces the supply of the electric power to the transmission antenna 2, for example.

As mentioned above, because the resonant type transmission power supply device according to this Embodiment 1 is configured in such a way as to input a pulse voltage to the transmission antenna 2 at the set intervals, and cause the resonance frequency of the transmission antenna 2 to be variable and perform the sweep detection of the resonance frequency, and detect the frequency characteristics of the transmission antenna 2 at that time, the resonant type transmission power supply device can detect the presence or absence of a foreign object in the electromagnetic field generated from the transmission antenna 2, and, when detecting a foreign object, can reduce or stop the supply of the electric power to the transmission antenna 2.

Further, because sensor coils 102 or the likes for foreign object detection, like those disposed in a conventional configuration, are not needed for the foreign object detection, the transmission and reception antennas 2 and 3 can be configured in a small size and in a lightweight. Further, a foreign object existing, in the electromagnetic field generated from the transmission antenna 2, at a long distance away from the transmission antenna 2 or in the vicinity of the center of the transmission and reception antennas 2 and 3 can be also detected. Further, because additional devices, such as sensor coils 102, are not needed, a cost reduction can be achieved. Further, because it is not necessary to drive additional devices such as sensor coils 102, low power consumption can be achieved.

Although the case in which the frequency characteristic detecting circuit 12 shown in FIG. 1 detects all of the frequencies of the reflection power, the voltage and the current, the phase difference between the voltage and the current, and the amplitudes of the reflection power, the voltage and the current is shown, this embodiment is not limited to this example. Although the accuracy of detection of a foreign object degrades, some of the detection items can be eliminated. However, either one of the amplitudes of the reflection power, the voltage and the current needs to be detected.

Further, commonality of the variable resonance frequency circuit 11 shown in FIG. 1 can be achieved as a resonance impedance adjusting circuit that adjusts the resonance impedance of the transmission antenna 2 (matches the resonance condition of the transmission antenna 2 to that of the reception antenna 3) at the time of adjusting the resonance coupling impedance of the transmission and reception antennas 2 and 3 according to a change of the input impedance of the reception antenna 3, and a cost reduction can be achieved.

### Embodiment 2

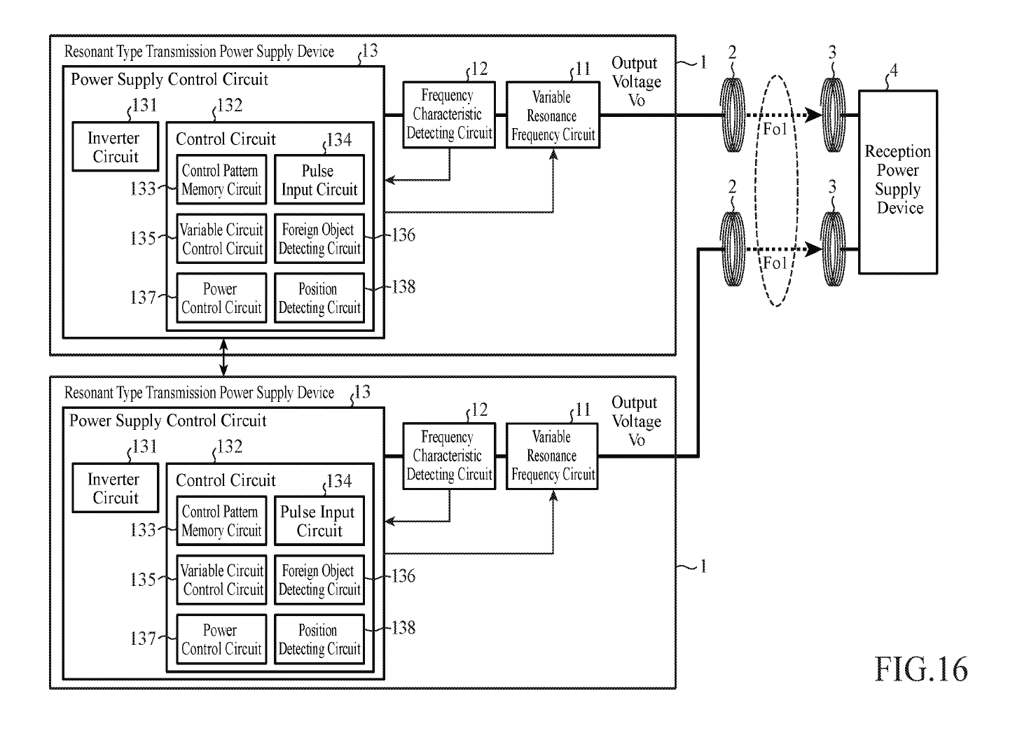

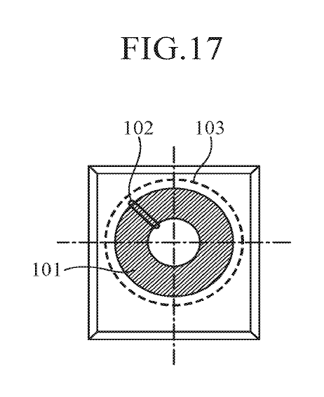

In Embodiment 2, a case in which a plurality of transmission and reception systems (each having a resonant type transmission power supply device 1, a transmission antenna 2 and a reception antenna 3) are disposed, and perform power transmission at opposite phases and at the same fixed frequency, respectively will be shown. In this case, the plurality of resonant type transmission power supply devices 1 construct a resonant type transmission power supply system according to the present invention. FIG. 16 is a diagram showing the configuration of a resonant type power transmission system provided with the resonant type transmission power supply system according to Embodiment 2 of the present invention. In the resonant type power transmission system according to Embodiment 2 shown in FIG. 16, two transmission and reception systems of the resonant type power transmission system according to Embodiment 1 shown in FIG. 1 are disposed, and a position detecting circuit 138 is added to a power supply control circuit 13 of each of the resonant type transmission power supply devices 1. Further, the power supply control circuits 13 of the systems are connected to each other via a connecting line, and a detection result acquired by each of frequency characteristic detecting circuits 12 can be shared between them. The other components are the same as those according to Embodiment 1 and are designated by the same reference character strings, and an explanation will be made as to only a different portion.

Each position detecting circuits 138 detects the position of a foreign object on the basis of a detection result (a waveform difference) acquired by the frequency characteristic detecting circuit 12 of each of the systems when the foreign object is detected by a corresponding foreign object detecting circuit 136.

Further, a corresponding power control circuit 137 reduces or stops the supply of the electric power to the corresponding transmission antenna 2 on the basis of the position of the foreign object detected by the position detecting circuit 138.

As a result, in which one of the transmission and reception systems the foreign object is located is determined. Further, whether the foreign object is located in the immediate vicinity of the transmission and reception antennas 2 and 3 or in the vicinity of the center between the transmission antenna 2 and the reception antenna 3 is determined. Then, it can be determined that the foreign object is garbage when the foreign object is located in the immediate vicinity of the transmission and reception antennas 2 and 3, or the foreign object is a person's hand, an animal or the like when the foreign object is located in the vicinity of the center. Further, whether or not the foreign object is a moving object can be determined. Therefore, the accuracy of detection of foreign objects is improved.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

The resonant type transmission power supply device according to the present invention can detect the presence or absence of a foreign object in an electromagnetic field generated from a transmission antenna, and, when detecting a foreign object, can perform reduction or stop of the power transmission, and the resonant type transmission power supply device is suitable for use as a resonant type transmission power supply device or the like that controls the supply of electric power to a transmission antenna.

### EXPLANATIONS OF REFERENCE NUMERALS

1 resonant type transmission power supply device, 2 transmission antenna, 3 reception antenna, 4 reception power supply device, 11 variable resonance frequency circuit, 12 frequency characteristic detecting circuit, 13 power supply control circuit, 111 variable control circuit, 112 coil, 113 motor control circuit, 114 FET, 115 capacitor, 116 FET, 131 inverter circuit, 132 control circuit, 133 control pattern memory circuit, 134 pulse input circuit, 135 variable circuit control circuit, 136 foreign object detecting circuit, 137 power control circuit, and 138 position detecting circuit.

1. A resonant type transmission power supply device comprising:
a pulse input circuit to input a pulse voltage to a transmission antenna at set intervals;
a variable resonance frequency circuit to cause a resonance frequency of said transmission antenna to be variable and perform sweep detection of the resonance frequency when a pulse voltage is inputted by said pulse input circuit;
a frequency characteristic detecting circuit to detect a frequency characteristic of said transmission antenna when the sweep detection of the resonance frequency is performed by said variable resonance frequency circuit;
a foreign object detecting circuit to detect presence or absence of a foreign object in an electromagnetic field generated from said transmission antenna on a basis of a detection result acquired by said frequency characteristic detecting circuit; and
a power control circuit to reduce or stop supply of electric power to said transmission antenna when a foreign object is detected by said foreign object detecting circuit.

2. The resonant type transmission power supply device according to claim 1, wherein said frequency characteristic detecting circuit detects, as the frequency characteristic, at least one of a frequency of reflection power from said transmission antenna, a frequency of a voltage inputted to said transmission antenna, and a frequency of a current inputted to said transmission antenna.

3. The resonant type transmission power supply device according to claim 2, wherein said frequency characteristic detecting circuit detects at least one of a phase difference between said voltage and said current, and amplitudes of said reflection power, said voltage and said current.

4. The resonant type transmission power supply device according to claim 1, wherein said transmission antenna performs wireless power transmission according to magnetic-field resonance with a reception antenna, and said variable resonance frequency circuit matches a resonance condition of said transmission antenna to that of said reception antenna.

5. The resonant type transmission power supply device according to claim 1, wherein said transmission antenna performs wireless power transmission according to electric-field resonance with a reception antenna, and said variable resonance frequency circuit matches a resonance condition of said transmission antenna to that of said reception antenna.

6. The resonant type transmission power supply device according to claim 1, wherein said transmission antenna performs wireless power transmission according to electromagnetic induction with a reception antenna, and said variable resonance frequency circuit matches a resonance condition of said transmission antenna to that of said reception antenna.

7. A resonant type transmission power supply system provided with a plurality of resonant type transmission power supply devices each of that controls supply of electric power to a corresponding one of transmission antennas, in which said transmission antennas operate at one fixed frequency, each of said resonant type transmission power supply devices comprising:
a pulse input circuit to input a pulse voltage to said corresponding transmission antenna at set intervals;
a variable resonance frequency circuit to cause a resonance frequency of said corresponding transmission antenna to be variable and perform sweep detection of the resonance frequency when a pulse voltage is inputted by said pulse input circuit;
a frequency characteristic detecting circuit to detect a frequency characteristic of said corresponding transmission antenna when the sweep detection of the resonance frequency is performed by said variable resonance frequency circuit;
a foreign object detecting circuit to detect presence or absence of a foreign object in an electromagnetic field generated from said corresponding transmission antenna on a basis of a detection result acquired by said frequency characteristic detecting circuit;
a position detecting circuit to, when a foreign object is detected by said foreign object detecting circuit, detect a position of said foreign object on a basis of a detection result acquired by each of said frequency characteristic detecting circuits; and
a plurality of power control circuits each to reduce or stop supply of electric power to said corresponding transmission antenna on a basis of the position of the foreign object detected by said position detecting circuit.
